(19) United States
(12) Patent Application Publication
(10) Pub. No.: US 2024/0042837 A1
(43) Pub. Date: Feb. 8, 2024

(54) GLASS RUN FOR DOOR OF VEHICLE

(71) Applicants: Hyundai Motor Company, Seoul (KR); Kia Corporation, Seoul (KR)

(72) Inventors: Min-Han Ryu, Gwangmyeong-si (KR); Ki-Won Kim, Hwaseong-si (KR)

(21) Appl. No.: 18/326,686

(22) Filed: May 31, 2023

(30) Foreign Application Priority Data
Aug. 3, 2022 (KR) 10-2022-0096935

(51) Int. Cl. B60J 5/04; B60J 10/76

(52) U.S. Cl. CPC B60J 5/0402; B60J 10/76

(57) ABSTRACT

In an embodiment a glass run for a door of a vehicle includes a core inserted in the glass run, wherein the core comprises a flat portion extending to a predetermined height in a longitudinal direction of the core and a punched portion extending in a direction perpendicular to the longitudinal direction of the core from the flat portion, and wherein the glass run is mountable to the door of the vehicle to support a door glass

### CROSS-REFERENCE TO RELATED APPLICATIONS

This application claims priority to Korean Patent Application No. 10-2022-0096935, filed on Aug. 3, 2022, which is incorporated herein by reference in its entirety.

### TECHNICAL FIELD

The present disclosure relates to a glass run for supporting a glass on a door of a vehicle, and more specifically, to a glass run for a door of a vehicle that may implement a flat external appearance without mounting a separate frame molding and increase a degree of freedom in design of an upper line of the door.

### BACKGROUND

A door glass is mounted on a door of a vehicle using a glass run. The glass run formed of a rubber material blocks the introduction of foreign substances and noise by filling a gap at a portion between a door panel and a door glass of the door on which the door glass is mounted.

Meanwhile, a circumference of the door is finished with a frame molding and exposed to the outside.

FIG. 1 shows a door 110 according to the related art, and a cross section of the door 110 is shown in FIG. 2.

A glass run 121 is fixedly fitted to the door panel 111, and the glass run 121 is assembled to a frame molding 123. Typically, the frame molding 123 is manufactured by roll-forming with a stainless steel.

Since the glass run 121 according to the related art has a structure in which the frame molding 123 is mounted on the glass run 121, there are limitations on the width and curvature of the frame molding 123, and thus the door 110 also has limitations of a degree of freedom in its design. In other words, since the frame molding 123 needs to be mounted on the glass run 121, the frame molding 123 may not be formed in a greater width. When the width of the frame molding 123 increases, it is difficult to assemble the frame molding 123 to the glass run 121. In addition, since an upper line of the door 110 should be formed to have a large curvature, a design in which the upper line changes rapidly may not be applied to the door 110. When the frame molding 123 is manufactured by a roll-forming method, since it is impossible to mold the frame molding 123 with a radius of the curvature R1 of the upper line less than 600 mm, there is a problem that a design in which the upper line changes rapidly may not be applied or the frame molding 123 needs to be manufactured by another method requiring a high manufacturing cost.

A core 122 for reinforcing the stiffness of a portion in which the glass run 121 is fixed to the door panel 111 is inserted into the glass run 121. The core 122 includes a flat portion 122a and a plurality of punched portions 122b vertically extending from the flat portion 122a and repeatedly disposed with a gap 122c therebetween. Although the flat portion 122a is positioned at a lower portion of the core 122 and is easy to follow the upper line of the door 110, a surface of the glass run 121 on which the punched portion 122b is projected is not flat or even, and thus the frame molding 123 needs to be applied. Therefore, this results in the limitations on the degree of freedom in design of the upper line of the door 110.

### SUMMARY

Embodiments provide a glass run for a door of a vehicle, which may be formed to have a flat surface exposed to the outside and may allow an upper line of the door to be implemented without limitations on a degree of freedom in design.

An exemplary glass run of a door for a vehicle according to the present disclosure for achieving the object may be mounted on the door for the vehicle to support a door glass, wherein a core may be inserted into the glass run, and the core may include a flat portion extended to a predetermined height in a longitudinal direction of the core, and a punched portion extended in a direction perpendicular to the longitudinal direction of the core from the flat portion.

A surface of the glass run, which is projected from the flat portion to a surface of the glass run may be formed flat and may become a finishing portion exposed to the outside in a state in which the glass run is assembled to a door panel.

The punched portion may be formed to extend from each of an upper end and a lower end of the flat portion.

The punched portion may be repeatedly formed in plural at a predetermined gap in the longitudinal direction of the core.

The finishing portion may be coated with silicone.

The glass run may be made of ethyl propyl diene monomer (EPDM), and the same gloss and color as polyvinyl chloride (PVC) may be implemented by the silicone coating.

A portion of the glass run in contact with the door glass may be coated with urethane.

The core may be inserted into an upper fixing portion fixed to the door panel at an upper portion of the glass run.

Meanwhile, an exemplary glass run of a door for a vehicle may be mounted on the door for the vehicle to support a door glass, wherein the glass run is made of synthetic rubber in a single member, and a portion of the glass run exposed to the outside in a state of being assembled to a door panel is coated with silicone.

A portion of the glass run in contact with the door glass may be coated with urethane.

According to the glass run of a door for a vehicle having the above configuration, the curvature radius of the upper line of the door may be reduced by changing the shape of the core inserted into the glass run in which the surface of the core corresponding to an exposed portion, when the glass run is mounted on the door panel, is formed as the flat portion and the punched portion is formed at the upper end and the lower end of the flat portion, thereby increasing the degree of freedom in design of the door.

In addition, since the surface of the glass run exposed to the outside after assembling may be formed flat, it is possible to achieve such an effect as mounting the frame molding only with the silicone coating, thereby reducing the number of processes and the cost.

### BRIEF DESCRIPTION OF THE DRAWINGS

FIG. 1 is a schematic view of a door to which a glass run is applied;

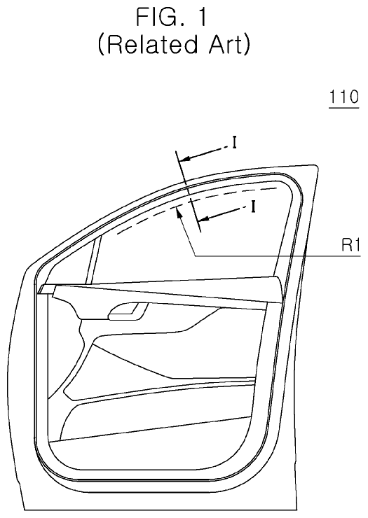

FIG. 2 is a cross-sectional view along line I-I of FIG. 1;

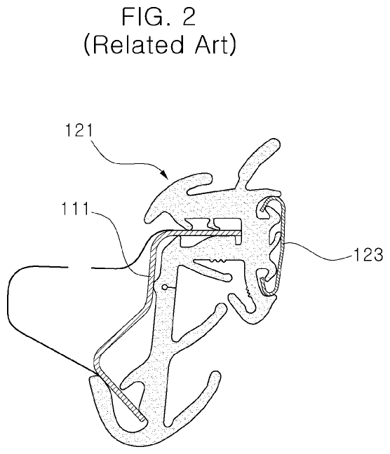

FIG. 3 is an exploded cross-sectional view showing an assembly relationship of the glass run;

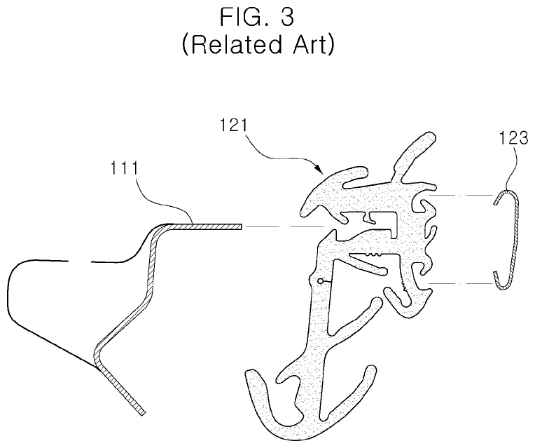

FIG. 4 is a cross-sectional view showing a state in which a core is inserted into the glass run;

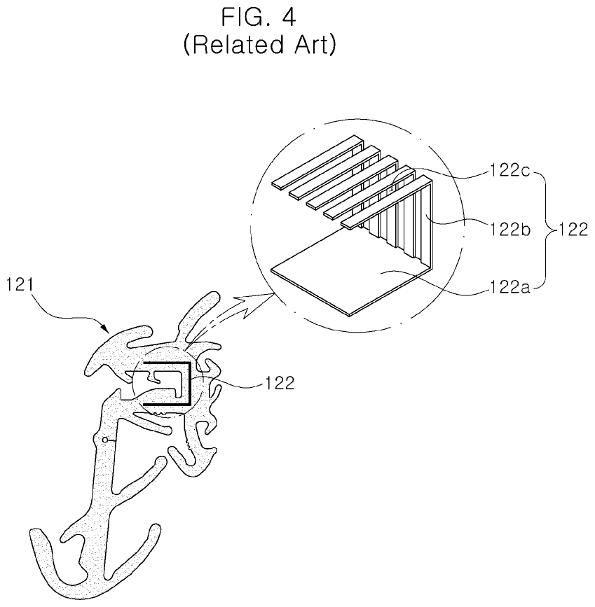

FIG. 5 is a schematic view of a door to which the glass run is applied according to embodiments;

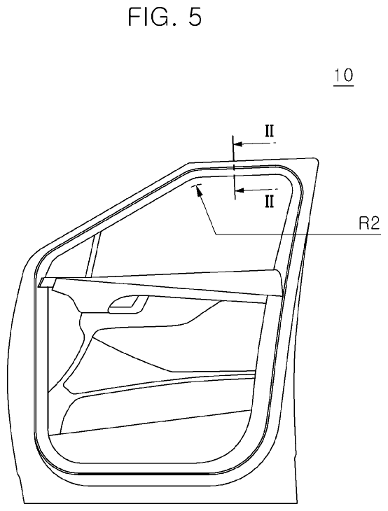

FIG. 6 is a cross-sectional view along line II-II of FIG. 5;

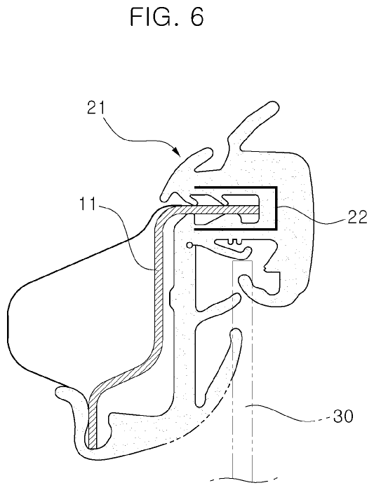

FIG. 7 is a partially exploded cross-sectional view showing an assembly relationship of the glass run according to embodiments;

FIG. 8 is a perspective view of a core inserted into the glass run according to embodiments; and

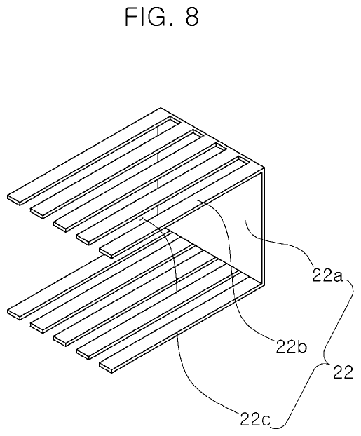

FIG. 9 is a schematic view showing a coated portion of the glass run according to embodiments.

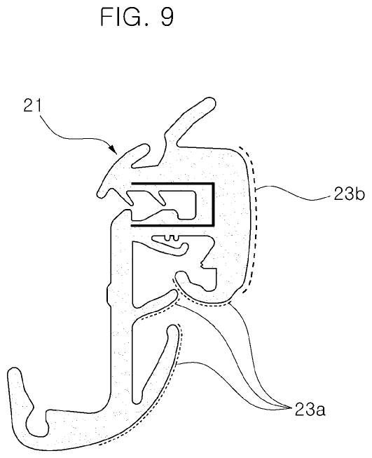

### DETAILED DESCRIPTION OF ILLUSTRATIVE EMBODIMENTS

Hereinafter, a glass run of a door for a vehicle according to the present disclosure will be described in detail with reference to the accompanying drawings.

According to the present disclosure, the glass run may be mounted on a door 10 for a vehicle (not shown) to support a door glass 30, in which a core 22 may be inserted into the glass run 21. The core 22 may include a flat portion 22a formed to extend to a predetermined height in a longitudinal direction of the core 22 and a punched portion 22b extended in a direction perpendicular to the longitudinal direction of the core 22 from the flat portion 22a.

The glass run 21 may be made of synthetic rubber, formed to have a predetermined cross-sectional shape, and may be mounted on the door panel 11.

An upper fixing portion 21a and a lower fixing portion 21b coupled to the door panel 11 are respectively formed on an upper portion and a lower portion of the glass run 21. A portion of the door panel 11 may be inserted into each of the upper fixing portion 21a and the lower fixing portion 21b so that the glass run 21 may be mounted on the door panel 11.

A sealing portion 21c in contact with an end portion of the door glass 30 to seal a portion between the door panel 11 and the door glass 30 may be formed between the upper fixing portion 21a and the lower fixing portion 21b. The sealing portion 21c may be formed to protrude from the glass run 21 and may have an end portion in contact with the door glass 30 to be sealed. A plurality of sealing portions 21c are formed at intervals and formed to be in contact with each of both side surfaces of the door glass 30.

The core 22 for providing a predetermined stiffness to prevent the glass run 21 from being separated from the door panel 11 in a state of being coupled to the door panel 11 may be inserted into the glass run 21.

The core 22 may allow the glass run 21 to provide the predetermined stiffness in a state of being inserted into the upper fixing portion 21a.

The core 22 may include a flat portion 22a and a plurality of punched portions 22b extending from each of an upper end and a lower end of the flat portion 22a.

The flat portion 22a may have a predetermined height and may be formed in the longitudinal direction of the core 22. Therefore, the flat portion 22a may have a belt shape.

Each of the punched portions 22b may be formed to extend in a direction perpendicular to the longitudinal direction of the core 22 from an upper end and a lower end of the flat portion 22a. Each of the punched portions 22b may be repeatedly formed in the longitudinal direction of the core 22, and a gap22c may be formed between adjacent punched portions 22b. In other words, each of the punched portions 22b may be repeatedly formed at the predetermined gap 22c in the longitudinal direction of the core 22.

The plurality of punched portions 22b may extend from each of the upper end and the lower end of the flat portion 22a and may have a shape bent from the flat portion 22a. In addition, each of the punched portion 22b may be manufactured by a punching process of one large flat plate member with the gap 22c and then by bending each of the punched portion 22b from the upper end and the lower end of the flat portion 22a.

Since the core 22 has the plurality of punched portions 22b bent from each of the upper end and the lower end of the flat portion 22a, the glass run 21 may be easily deformed as following an upper line of the door 10. Therefore, the glass run 21 may be applied to the door 10 even when the upper line of the door 10 changes rapidly.

For example, conventionally, the radius R1 of the upper line needs to be 600 mm or more, but since a radius R2 of the upper line of the door 10 in the present disclosure may be 50 mm or more, the upper line of the door 10 may be designed even in a rapidly changed shape and manufactured without increasing the production cost.

The glass run 21 may be made of synthetic rubber such as ethyl propyl diene monomer (EPDM).

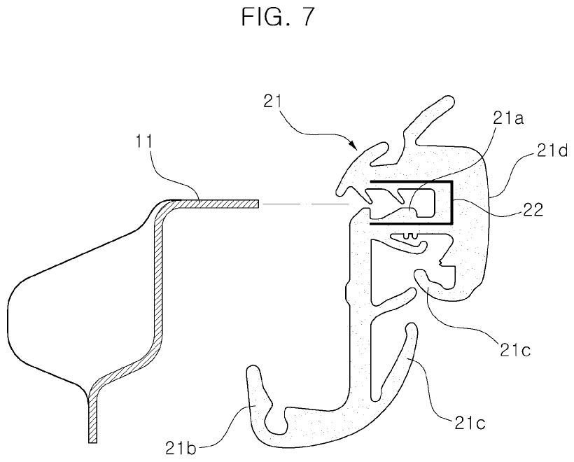

In particular, a portion of the glass run 21 exposed to the outside may be finished as it is without a finishing member such as the frame molding 123 in the related art. Therefore, a portion in which the frame molding 123 of the related art has been exposed to the outside may become a finishing portion 21d formed to have a flat surface as shown in FIG. 7.

Unlike the conventional frame molding 123 which has been additionally mounted on the glass run 121, the finishing portion 21d may be simultaneously formed when the glass run 21 is manufactured, so the number of processes may be reduced.

In particular, the finishing portion 21d may have a flat shape when exposed to the outside, which may be supported by the flat portion 22a of the core 22 inserted into the glass run 21. In other words, an imaginary surface projected from the flat portion 22a to a surface of the glass run 21 may become the finishing portion 21d which is exposed to the outside in a state when the glass run 21 is assembled to the door panel 11.

Here, since the finishing portion 21d may be exposed to the outside as it is, the surface of the finishing portion 21d may be coated with silicone 23b so that a gloss of the finishing portion 21d may be reduced and a different color and a different feeling from components mounted around the finishing portion 21d may be improved. Since the components mounted around the finishing portion 21d, such as a quarter garnish, may be made of polyvinyl chloride (PVC) or thermoplastic vulcanizates (TPV). When the glass run 21 is made of EPDM, the finishing portion 21d may cause the different feeling, and colors are not matched with each other. Therefore, by coating the finishing portion 21d with the silicone 23b, the same gloss and color as the PVC material may be implemented.

The sealing portion 21c of the glass run 21 may be coated with urethane 23a for waterproofing.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A glass run for a door of a vehicle, the glass run comprising:
a core inserted in the glass run,
wherein the core comprises:
a flat portion extending to a predetermined height in a longitudinal direction of the core, and
a punched portion extending in a direction perpendicular to the longitudinal direction of the core from the flat portion, and
wherein the glass run is mountable to the door of the vehicle to support a door glass.

2. The glass run of claim 1, wherein an imaginary surface of the glass run, which is projected from the flat portion to a surface of the glass run, is flat and becomes a finishing portion exposed to an outside when the glass run is assembled to a door panel.

3. The glass run of claim 1, wherein the punched portion is extending from each of an upper end and a lower end of the flat portion.

4. The glass run of claim 1, wherein the punched portion is repeatedly arranged at predetermined gaps along the longitudinal direction of the core.

5. The glass of claim 2, wherein the finishing portion is coated with silicone.

6. The glass run of claim 5, wherein the glass run is made of ethyl propyl diene monomer (EPDM), and the same gloss and color as polyvinyl chloride (PVC) are implemented by the silicone coating.

7. The glass run of claim 1, wherein a portion of the glass run in contact with the door glass is coated with urethane.

8. The glass run of claim 1, wherein the glass run includes an upper fixing portion and a lower fixing portion coupled to a door panel.

9. The glass run of claim 8, wherein the core is inserted into the upper fixing portion fixed to the door panel on an upper portion of the glass run.

10. The glass run of claim 9, wherein a portion of the door panel is inserted into each of the upper fixing portion and the lower fixing portion to mount the glass run on the door panel.

11. The glass run of claim 9, wherein a sealing portion is formed between the upper fixing portion and the lower fixing portion to seal a portion between the door panel and the door glass.

12. The glass run of claim 11, wherein the sealing portion protrudes from the glass run and has an end portion in contact with the door glass to be sealed.

13. A glass run for a door of a vehicle, the glass run comprising:
synthetic rubber,
wherein the glass run is a single member, and
wherein a portion of the glass run is exposed to an outside when assembled to a door panel,
wherein the portion is coated with silicone, and
wherein the glass run is mountable to the door of the vehicle to support a door glass.

14. The glass run of claim 13, wherein a portion of the glass run in contact with the door glass is coated with urethane.

15. The glass run of claim 13,
wherein an imaginary surface of the glass run, which is projected from a flat portion to a surface of the glass run, is flat and becomes a finishing portion exposed to the outside when the glass run is assembled to the door panel,
wherein a core is inserted into the glass run,
wherein the core comprises:
a flat portion extending to a predetermined height in a longitudinal direction of the core, and
a punched portion extending in a direction perpendicular to the longitudinal direction of the core from the flat portion,
wherein the punched portion is repeatedly arranged at predetermined gaps in the longitudinal direction of the core.

16. The glass run of claim 15, wherein the punched portion is extended from each of an upper end and a lower end of the flat portion.

17. The glass run of claim 15, wherein the glass run includes an upper fixing portion and a lower fixing portion coupled to the door panel.

18. The glass run of claim 17, wherein a portion of the door panel is inserted into each of the upper fixing portion and the lower fixing portion to mount the glass run on the door panel.

19. The glass run of claim 17, wherein a sealing portion is formed between the upper fixing portion and the lower fixing portion to seal a portion between the door panel and the door glass.

20. The glass run of claim 19, wherein the sealing portion protrudes from the glass run and has an end portion in contact with the door glass to be sealed.
